(19) United States
(12) Patent Application Publication
(10) Pub. No.: US 2009/0111077 A1
(43) Pub. Date: Apr. 30, 2009

(54) Computerized system and method using a symbolic language for dance

(76) Inventors: Karen A. Buchheim, Virginia Beach, VA (US); Caroline A. Petrulis, Virginia Beach, VA (US)

Correspondence Address: WILLIAMS MULLEN, 222 CENTRAL PARK AVENUE, SUITE 1700, VIRGINIA BEACH, VA, 23462, US

(21) Appl. No.: 11/980,869

(22) Filed: Oct. 31, 2007

(51) Int. Cl. G09B 9/00

(52) U.S. Cl. 434/250; 434/323

(57) ABSTRACT

Disclosed is a system, method, and computer readable medium for choreographing and teaching dance using symbols to represent dance steps. Input via computer peripheral devices is received and mapped to one of a plurality of stored dance steps stored in memory. The dance steps can be expressed in a plurality of modes. The plurality of mapped dance steps is then ordered into a choreographed dance routine. A dance routine file containing the dance routine comprised of the plurality of ordered and mapped dance steps is then created. The dance routine file can be printed, stored, and/or displayed using computer peripheral devices.

### FIELD OF INVENTION

Various embodiments of this invention relate generally to a computerized system and method using symbols to represent tap dance steps for choreographing and teaching dance.

### BACKGROUND OF THE INVENTION

Choreographing and teaching tap dance using written notation has historically been a complex and time consuming process. For example, tap dance terms of art can include such lengthy definitions as those for “Flash Steps” and “Paddle and Roll.” “Flash Steps” are steps added to increase visual excitement to a tap dance that include splits, wings, and acrobatics. “Paddle and Roll” is a style of tap dance which emphasizes close to the floor, very fast taps, including paradiddles, scuffles, riffles and nerve taps. Tap dance “Movements” can also include lengthy terms and definitions. For example, “Draw/Pull/Spank” means to slide the working foot along the floor toward the supporting leg with no weight change; and “Left Inside Turn” means to turn left (forward) while standing on the left leg. Finally, tap dance “Patterns” may include lengthy terms and definitions such as “Falling off the Log” which means an exaggerated falling to the side movement, crossing front, side, back, side; like trying to remain standing on a rolling log. “Shuffle Step” means a brush forward of the foot followed by a pull (backward brush) ending with a step all on the same foot. From these few examples of tap dance terms and definitions, it is easy to see how describing a tap dance using written notation could become a cumbersome process; difficult to create and difficult to read. Hereafter dance steps, patterns and movements are collectively referred to as steps.

### SUMMARY OF INVENTION

Embodiments of the present invention provide a computerized system and method for learning tap dance through the symbolic depiction of tap dance steps. The system employs symbols that are strung together to form dance routines of varying length that create a graphical display for a dance that succinctly and exactly parallels lengthy written notation.

Embodiments of the present invention, therefore, simplify the reading, writing, and creation of tap dance choreography in a manner analogous to the way that musical symbols (e.g., eighth note, and dotted quarter note) have simplified notation for western music. The present invention provides a means for creating dance in a format analogous to sheet music created and read by musicians. For added depth of composition, the symbolic tap dance language can be accompanied by indications of beats per measure, notations of foot-placement, word abbreviations and or any additional instructions provided by the program user.

One embodiment of the present invention maps characters from a standard computer keyboard to symbols that correspond to specific dance steps allowing for high-speed creation and recordation of dance step combinations. The combinations can be of varying length and complexity. For example, a user can hear the rhythms of tap dance in performance and “play” them on the keyboard simultaneously; thereby creating and recording the dance steps in real time with detailed accuracy. Additionally, by using this technology, choreographic notation describing tap dance routines can be shared electronically, saved, stored and or printed.

### BRIEF DESCRIPTION OF THE DRAWINGS

FIG. 1 is a block diagram of system components used in various embodiments of the present invention.

FIG. 2 is a flowchart illustrating a process for an embodiment of the present invention.

FIG. 3 is a block diagram of various software components used in various embodiments of the present invention.

FIGS. 4A-E illustrates representative symbols with corresponding dance steps and a corresponding key of a typical computer keyboard for an embodiment of the present invention.

FIG. 5A-B illustrates a mapping of dance step symbols to keys of a typical computer keyboard for an embodiment of the present invention.

FIG. 6 illustrates a Waltz Clog in an embodiment of the present invention.

### DETAILED DESCRIPTION OF THE INVENTION

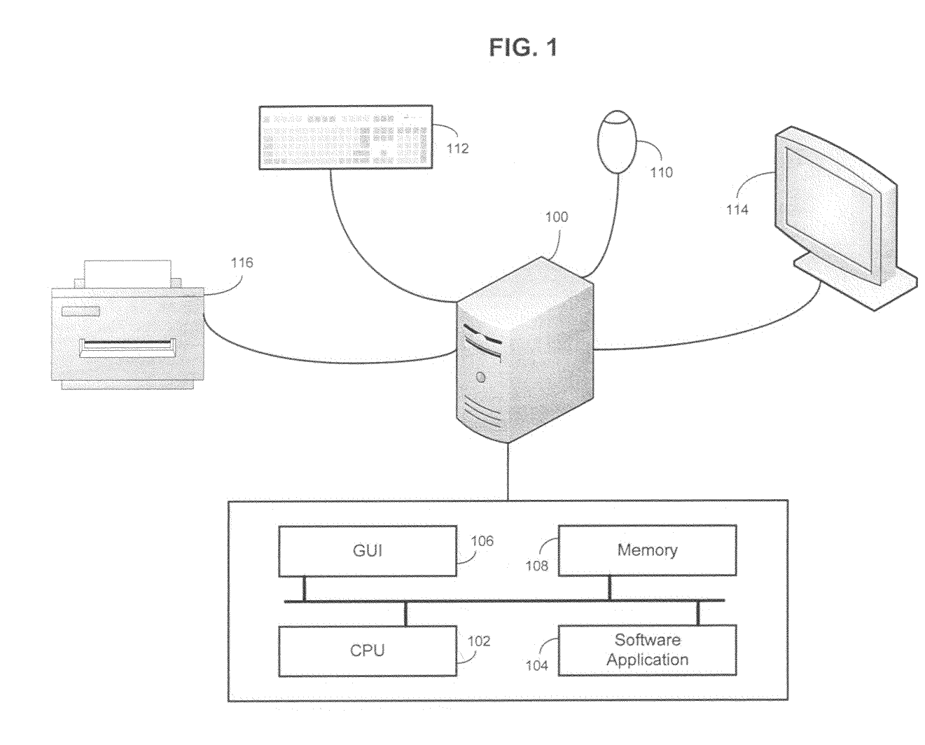

In various embodiments, the present invention provides a computerized system using symbols to represent dance steps for choreographing and teaching dance. FIG. 1 is a block diagram of system components used in various embodiments of the present invention.

A computer 100 is connectable to a variety of peripheral devices including a printer 116, a mouse 110, a keyboard 112, and a display 114. Other peripheral devices can be attached to the computer system to provide additional input and output functionality. The computer 100 includes a processor 102 that controls and manages the execution of a software application 104. The processor 102 also controls and manages access to the peripheral devices described above as well as a graphical user interface (GUI) 106 and memory/data storage 108. The processor 102 is capable of executing interactive instructions utilizing the graphical user interface 106 as presented on display 114 and received as input via peripheral devices such as the keyboard 112 and mouse 110, among others. Such received input is converted to instructions by the processor 102 that select and/or manipulate the software application 104 such as with scrollable windows, menus, tool bars and icon representations of data and functions. It is contemplated that the present invention may be implemented by workstation, desktop, or laptop computer connectable with a local area network, wide area network, the Internet, wireless fidelity, or other suitable network systems.

The software application 104 allows a user to create and modify new or existing dance routines using the tools provided by the system. The resulting dance routines can be stored, printed, and/or displayed upon request of the user.

The memory/data storage 108 device serves to store existing dance routines created using the software application 104 as well as the raw data used by the software application 104 to create or modify the dance routines. This includes data representative of dance step symbols, keyboard mappings, dance step descriptions, among other data as described herein.

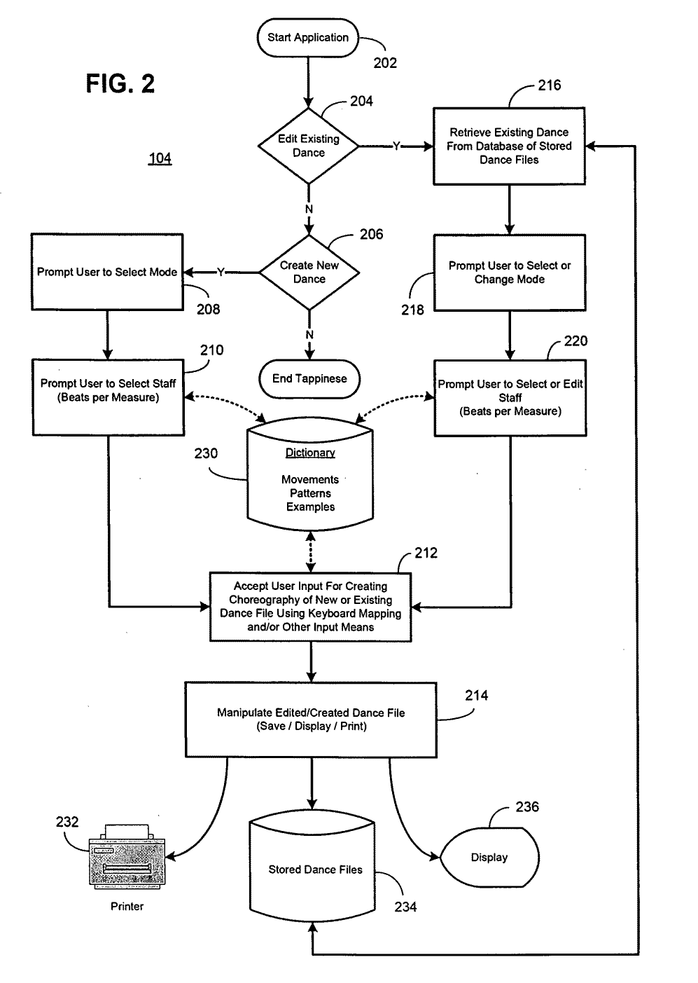

FIG. 2 is a flowchart illustrating a process for an embodiment of the present invention. When the software application 104 is launched 202, the user can opt to edit an existing dance 204 or create a new dance 206. If the decision is to create a new dance 206 the software application 104 displays the screen that prompts for user input to create a new dance routine. The user is prompted to select the mode 208 of the new dance. Some of the mode choices include information, foot, count, step, or symbol. The user is then prompted to select a staff 210 designating beats per measure.

Once the basic constructs of the new dance routine have been input in steps 208 and 210, the software application 104 will accept user input defining the dance routine 212. The input can be received from any combination of the attached input devices (keyboard, mouse, voice, touch screen, etc.). As an example, the standard keys of a keyboard can be mapped to a set of dance steps such that depressing the “Q” key could be mapped to a “drag” step. Or, part of the display can show the set of available dance steps such that the user can select, drag, and/or drop a desired dance step into another area of the display designated for composition of the dance being developed or modified. Touch screen technology can be used in lieu of a mouse (pointing device).

The data representing the dance steps, movements, patterns, modes, and measures is stored within the computer system 230 within a dictionary type repository or database in memory 108. Once the user deems the dance routine complete (or at any time during composition), she can manipulate the dance routine/file 214 within the broader computer system. The dance routine file can be printed 232, displayed 236, and/or stored as a routine 234 for later manipulation including further editing if desired.

If the decision is to edit an existing dance 204 the software application 104 displays the screen that prompts for user input to retrieve an existing dance from a database of stored dance routines 216. The user then reviews the mode selection 218 and staff measure selection 220 and has the opportunity to edit same. At this point, the user is confronted with the same scenario as in creating a new dance and the editing/manipulation process can occur as previously described in steps/processes 212 and 214.

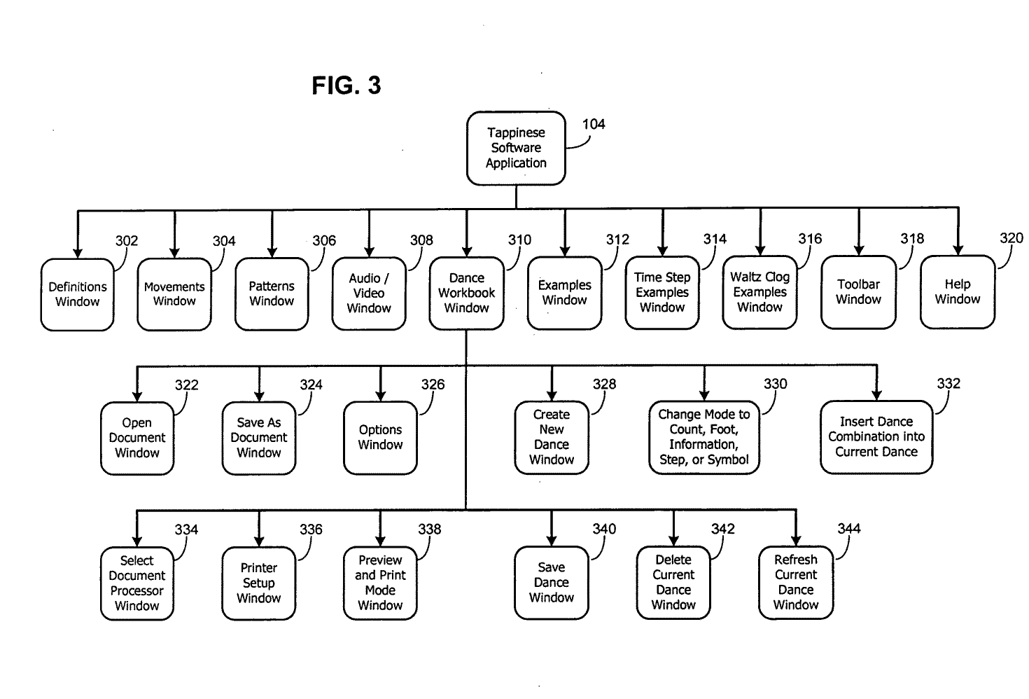

FIG. 3 is a block diagram of various software components used in various embodiments of the present invention. These components variously involve selecting or manipulating program functions of the software application 104 such as scrollable windows, menus, tool bars and icon representations of data and various functions. In one embodiment of the present invention options include a definitions window 302; a movements window 304; a patterns window 306; an audio/video window 308; a dance workbook window 310; an examples window 312; a time step examples window 314; a waltz clog examples window 316; a toolbar window 318; and a help document window 320.

The dance workbook window 310 controls options to an open document window 322, a save as document window 324, an options window 326, create a new dance window 328, change mode to count, foot, information, step, or symbol 330, insert a dance combination into the dance 332, a select document processor window 334, a printer setup window 336, a preview and print mode window 338, save dance window 340, delete the current dance window 342, and refresh the current dance window 344.

As an example, a description of a user operating the system and software to create a new dance routine is explained. The user begins by executing the software application 104 on her computer 100. She then navigates the menu options to find and select the dance workbook 310 and then further selects the option to create a new dance 328. The software application 104 allows her to select a mode 208 for display purposes. The software application 104 also allows her to select and set up the measure 210 of the dance by selecting beats per minute for the dance. The user can now use the keyboard 112 to create a string of dance steps. The keystrokes are translated into dance steps based on the keyboard mode selected and the keyboard mapping described below.

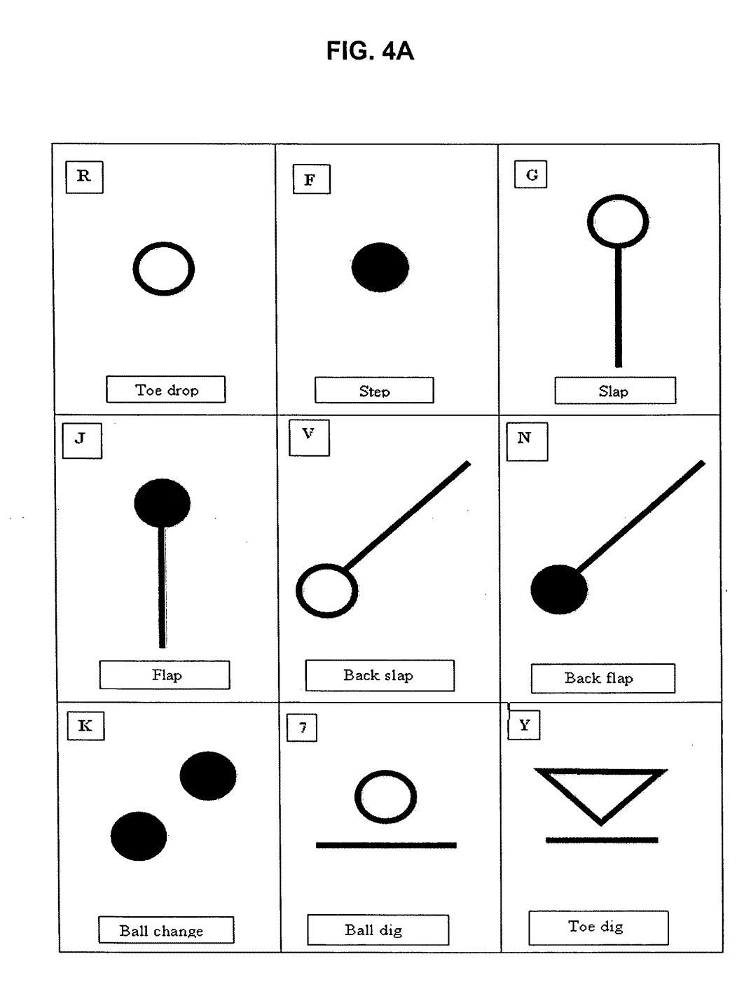

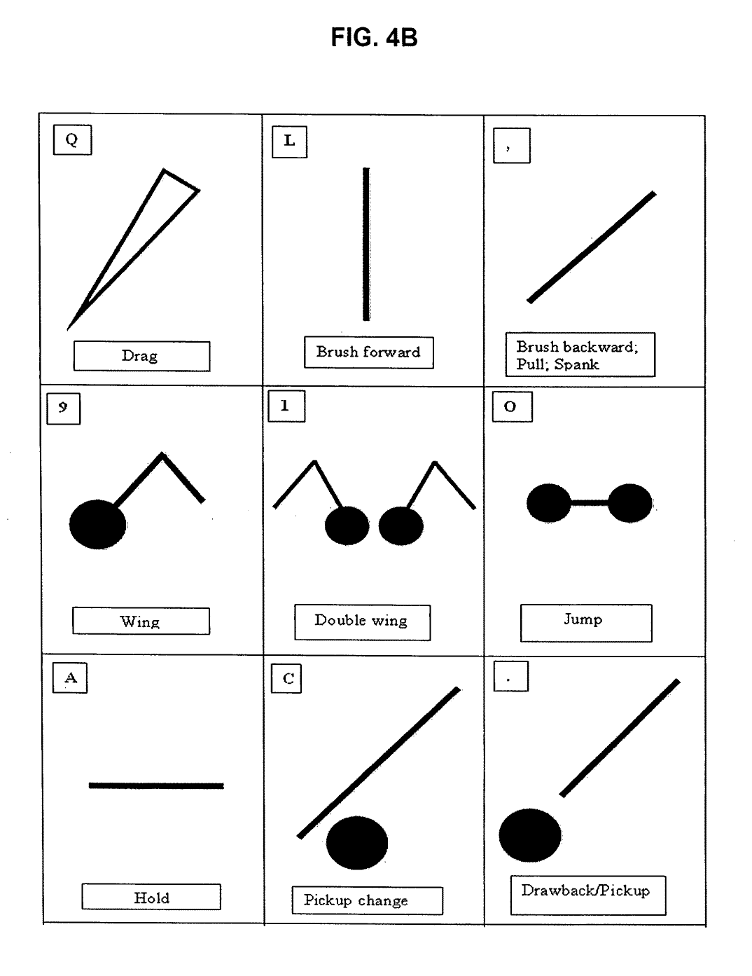

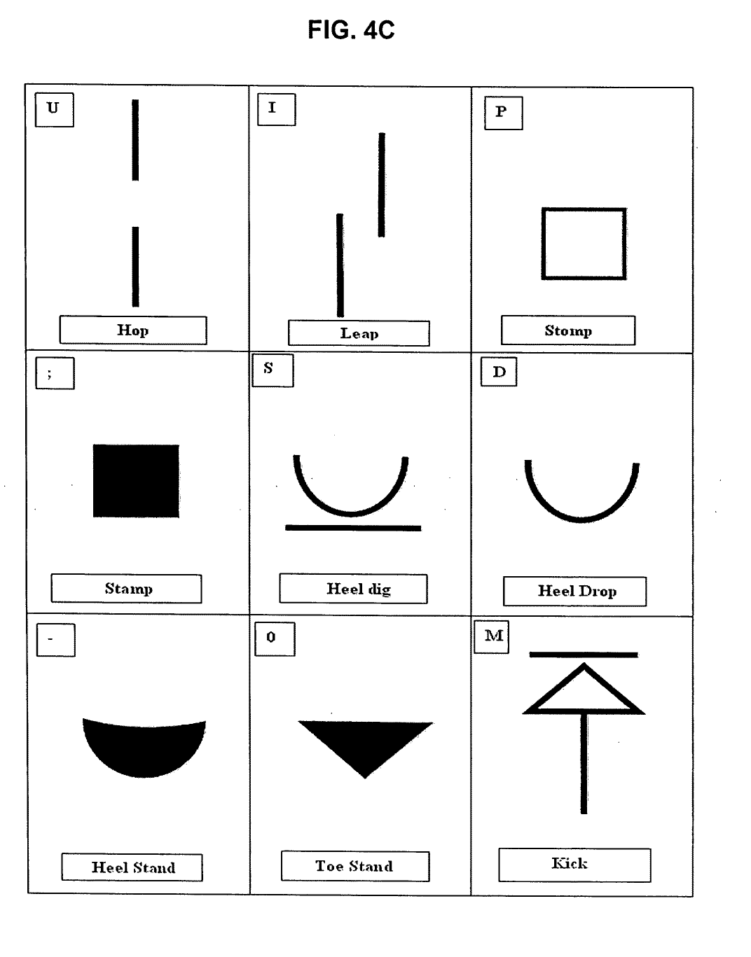

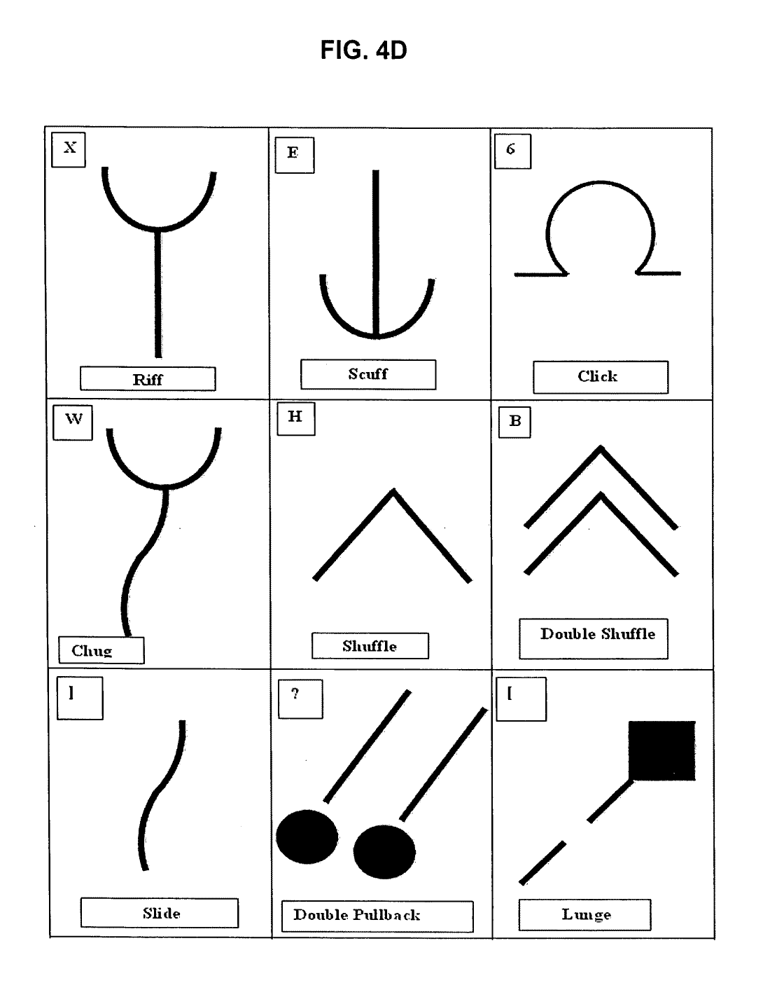

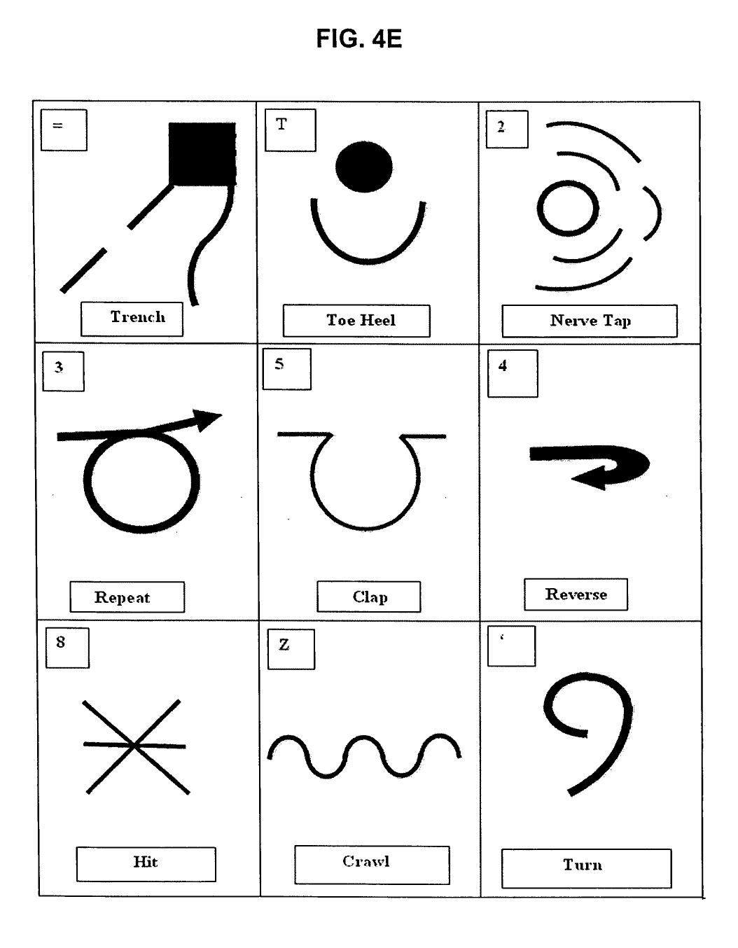

An aspect of an embodiment of the invention is a plurality or set of symbols having a one-to-one relationship to dance steps, such that a sequence of said plurality of symbols produces a symbolic translation of dance. Creating and mapping these symbols to a computer keyboard is a feature of the currently described software application 104. Representative symbols used in one embodiment of the present invention with corresponding dance step names and a corresponding key of a typical computer keyboard to which it is mapped are shown in FIGS. 4A-E. Each letter on the keyboard is associated with a dance symbol as shown as well as a dance symbol description. For instance, in FIG. 4A, the letter “N” is associated with the dance step symbol representative of a “back flap”. The exact mappings or one-to-one correspondence between dance step symbol/description and keyboard key is illustrative only. For instance, the letter “K” could just have easily been chosen to represent the “back flap” dance step symbol/description.

One embodiment of the present invention facilitates the writing of tap dance using the symbols shown in FIGS. 4A-E. To display the created dance in these symbols requires the user to select the symbol mode in the software application 104 when using the dance workbook 310 of the software application 104. As illustrated in FIG. 3, other modal options for display of dance may include a Count Mode, Step Mode, Foot Mode, and Information Mode 330. In each of these modes, designated keys and combinations of keys correspond to specific symbols and or instructions while other keys remain consistent with the standard input of a computer keyboard. Count Mode provides the rhythmic pattern. Step Mode provides the name of the dance step using abbreviations. Foot Mode indicates foot placement in executing the designated dance step. In Information Mode, standard QWERTY computer keyboard input provides the user opportunity to insert information necessary to guide the reader. Additionally, modular entities and/or objects may be organized into files that represent tap dance phrases, combinations, or complete dances.

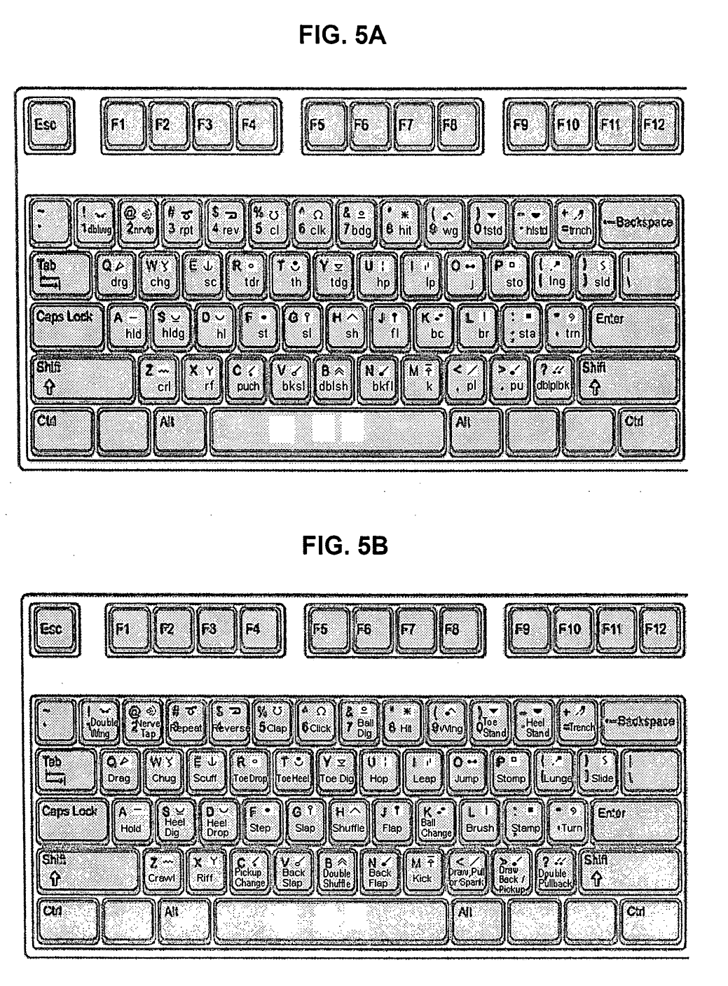

FIGS. 5A-B illustrate representative symbols with corresponding dance step names and a corresponding key of a typical computer keyboard for an embodiment of the present invention. Specifically, FIG. 5A illustrates a mapping of dance step symbols with dance step abbreviations mapped to keys of a typical computer keyboard for an embodiment of the present invention. FIG. 5B illustrates a mapping of dance step symbols with fuller dance step names mapped to keys of a typical computer keyboard for an embodiment of the present invention.

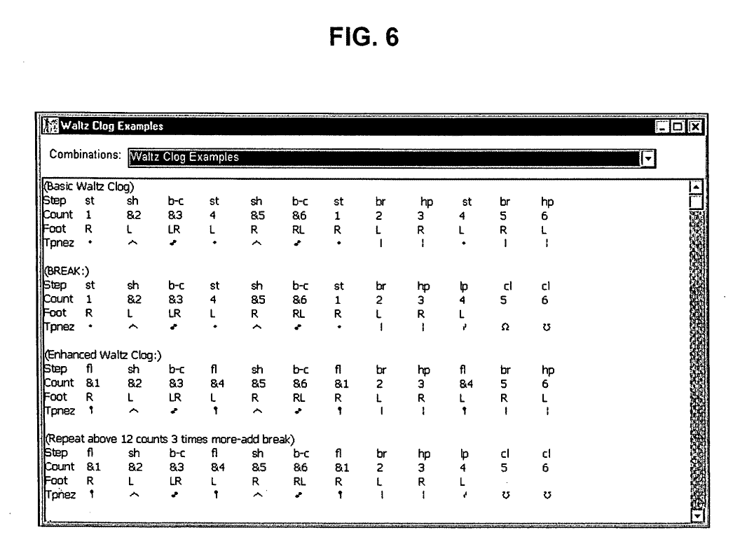

A sample display of the application program is given in FIG. 6. Specifically, FIG. 6 illustrates a commonly known Waltz Clog in multiple modes including information, step, count, foot, and symbolic modes. Of course, any type of dance is eligible for expression by such a plurality of symbols and other respective modes using this software application.

The data input device 112 illustrated in the block diagram of FIG. 1 may be a standard keyboard, as previously discussed. However, other input devices, such as but not limited to, speech translators, keypads, game consoles, etc., may be used. Information concerning the symbols and the corresponding dance steps are in one embodiment of the present invention maintained on a resident computer memory medium, so as to be available to an implementing or supporting application program. However, a portable or remote medium (e.g., network or internet) may also be provided, depending on the embodiment. Thus, the symbolic translation of a dance may be then stored in computer files on some local or remote storage medium.

In one embodiment of the present invention the application program provides a lesser graphical user interface nested within the operating system's greater graphical user interface. This lesser graphical user interface could include a sample interface for selecting, opening and using sample files and a creating interface for creating and manipulating files. Each of the plurality of symbols is thus a modular entity and represents a specific and unique dance step, and the modular entity is an ensemble of computer based attributes having a unique identification number so that the ensemble can be manipulated as a single object having unique characteristics. Other aspects of the application program for an exemplary embodiment are described in greater detail below.

In summary and as described above, in various embodiments, the present invention is a computer readable medium storing a computer program and method for choreographing and teaching dance using symbols to represent dance steps. The computer system includes a processor capable of executing instructions of an operating system, a memory medium, a display device, a user input device, and a software application stored on the memory medium providing storage files, modal options, and a plurality of symbols having a one-to-one relationship to dance steps that are mapped to designated input options for an input device.

As will be appreciated by one of skill in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any suitable computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

Any prompts associated with the present invention may be presented and responded to via a graphical user interface (GUI) presented on the display of the mobile communications device or the like. Prompts may include audio, vibrator, etc.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

What is claimed is:

1. A method of choreographing and teaching dance using symbols to represent dance steps comprising:
receiving and mapping an input to one of a plurality of stored dance steps wherein the dance steps can be expressed in a plurality of modes;
ordering a plurality of mapped dance steps into a choreographed dance routine; and
creating a dance routine file containing the dance routine comprised of the plurality of ordered and mapped dance steps.

2. The method of claim 1 wherein the plurality of modes in which the dance steps can be expressed include a symbol mode, a step mode, a count mode, a foot mode, and an information mode.

3. The method of claim 2 further comprising changing the mode of expression for the dance steps in a dance routine file.

4. The method of claim 1 wherein receiving and mapping an input to a stored dance step comprises associating a keyboard keystroke from a standard QWERTY keyboard with one of the stored dance steps.

5. The method of claim 1 wherein receiving and mapping an input to a stored dance step comprises associating a sensed touch at a specific location on a touch screen display with one of the stored dance steps.

6. The method of claim 2 further comprising displaying the dance routine file in the mode specified.

7. The method of claim 2 further comprising storing the dance routine file in the mode specified.

8. The method of claim 2 further comprising printing the dance routine file in the mode specified.

9. The method of claim 1 wherein the plurality of stored dance steps represent tap dance steps.

10. A computer readable medium storing a computer program product for choreographing and teaching dance using symbols to represent dance steps, the computer readable medium comprising:
computer program code for receiving and mapping an input to one of a plurality of stored dance steps wherein the dance steps can be expressed in a plurality of modes;
computer program code for ordering a plurality of mapped dance steps into a choreographed dance routine; and
computer program code for creating a dance routine file containing the dance routine comprised of the plurality of ordered and mapped dance steps.

11. The computer readable medium of claim 10 wherein the plurality of modes in which the dance steps can be expressed include a symbol mode, a step mode, a count mode, a foot mode, and an information mode.

12. The computer readable medium of claim 11 further comprising computer program code for changing the mode of expression for the dance steps in a dance routine file.

13. The computer readable medium of claim 10 wherein the computer program code for receiving and mapping an input to a stored dance step comprises computer program code for associating a keyboard keystroke from a standard QWERTY keyboard with one of the stored dance steps.

14. The computer readable medium of claim 10 wherein the computer program code for receiving and mapping an input to a stored dance step comprises computer program code for associating a sensed touch at a specific location on a touch screen display with one of the stored dance steps.

15. The computer readable medium of claim 11 further comprising computer program code for displaying the dance routine file in the mode specified.

16. The computer readable medium of claim 11 further comprising computer program code for storing the dance routine file in the mode specified.

17. The computer readable medium of claim 11 further comprising computer program code for printing the dance routine file in the mode specified.

18. The computer readable medium of claim 10 wherein the plurality of stored dance steps represent tap dance steps.

19. A system for choreographing and teaching dance using symbols to represent dance steps comprising:
a processor;
a graphical user interface coupled with the processor for use during a dance routine editing and composition process;
a display coupled with the processor for displaying the dance steps during the dance routine editing and composition process;
a storage device coupled with the processor for storing a plurality of dance steps; and
a software application coupled with and executable by the processor for:
receiving and mapping an input to one of the plurality of stored dance steps wherein the dance steps can be expressed in a plurality of modes;
ordering a plurality of mapped dance steps into a choreographed dance routine; and
creating a dance routine file containing the dance routine comprised of the plurality of ordered and mapped dance steps.

20. The system of claim 19 wherein the plurality of modes in which the dance steps can be expressed include a symbol mode, a step mode, a count mode, a foot mode, and an information mode.

21. The system of claim 20 wherein the software application further changes the mode of expression for the dance steps in a dance routine file.

22. The system of claim 19 wherein receiving and mapping an input to a stored dance step comprises associating a keyboard keystroke from a standard QWERTY keyboard with one of the stored dance steps.

23. The system of claim 19 wherein receiving and mapping an input to a stored dance step comprises associating a sensed touch at a specific location on a touch screen display with one of the stored dance steps.

24. The system of claim 20 wherein the display displays the dance routine file in the mode specified.

25. The system of claim 20 wherein the storage device stores the dance routine file in the mode specified.

26. The system of claim 20 further comprising a printer coupled with the processor for printing a dance routine file in a mode specified.

27. The system of claim 19 wherein the plurality of stored dance steps represent tap dance steps.
